(19) United States
(12) Patent Application Publication
(10) Pub. No.: US 2009/0037833 A1
(43) Pub. Date: Feb. 5, 2009

(54) Electronic Device and Enhancing Document Viewing In Electronic Device

(76) Inventors: Roope Rainisto, Helsinki (FI); Petri Tolppanen, Kauniainen (FI); Matti Vaisanen, Helsinki (FI)

Correspondence Address: Hollingsworth & Funk, LLC, 8009 34th Avenue South, Suite 125, Minneapolis, MN, 54425, US

(21) Appl. No.: 11/922,645

(22) PCT Filed: Jun. 30, 2005
(86) PCT No.: PCT/FI2005/050258

§ 371 Date: Dec. 20, 2007

(51) Int. Cl. G06F 3/048

(52) U.S. Cl. 715/767

(57) ABSTRACT

A method of enhancing document viewing in an electronic device and an electronic device are provided. The device comprises a display, a keyboard, and a controller operationally connected to the keyboard and the display, wherein the controller is configured to display on the display a document comprising several elements capable of obtaining focus. The controller is further configured to define a predetermined number of focus nodes on the display, associate each focus node with a press of a predetermined key of the keyboard, detect a press of a key of the keyboard, select a focus node on the basis of the detected key press, determine the element capable of obtaining focus, which is closest to the selected focus node, set the focus to the determined element.

### FIELD

The invention relates to an electronic device and to enhancing the viewing documents in an electronic device, wherein documents comprising several elements capable of obtaining focus are displayed on a display.

### BACKGROUND

Many electronic devices comprising a display are used to view documents. The devices may be used to execute applications which display many kinds of documents on the display of the device. The documents may comprise many elements, some of which may be links to other parts of the document or to another document. An example of such an application is a web browser which displays web documents.

Elements in a document may be so-called focus elements. A focus element is capable of obtaining focus. Focus refers to a property of a display element. The element having focus receives the keyboard commands given by the user. In many cases, a cursor is shown on the screen surrounding or underlining the element having focus. This way the user knows which element has focus. Changing focus from one element to another may be done using a keyboard, for instance by pressing a given key, such as a tabulator or an arrow key. Displaying a focus element also facilitates document scrolling by moving the focus element over the edge of the browser area.

Typically, when a new document is displayed on the display, no element has focus. When the user presses a key reserved for focus selection, focus is typically given to the first element capable of obtaining focus, starting from the top left corner of the document.

The solution for giving focus to the first element of a document is not ideal for navigating the document with keys. In many cases, especially when the document is a web page, the user wishes to set focus to the last focusable element of the document, not to the first. In order to change focus to the wanted element, or to scroll the document by moving the focus over the edge of the display, the user must in almost every situation move focus across each individual focusable element on the document with several key presses. Especially in limited-resource devices, such as mobile phones or personal digital assistants (PDA), moving focus across multiple elements on the display may be quite slow, and more intelligent mechanisms of focus setting and behaviour are required.

### BRIEF DESCRIPTION OF THE INVENTION

An object of the invention is to provide an improved solution for enhancing document viewing in an electronic device. According to an aspect of the invention, there is provided a method of enhancing document viewing in an electronic device, wherein a document comprising several elements capable of obtaining focus is displayed on a display of the device. The method comprises defining a predetermined number of focus nodes on the display; associating each focus node with a predetermined key press; detecting a key press; selecting a focus node on the basis of the key press; determining the element capable of obtaining focus, which is closest to the selected focus node; and setting focus to the determined element.

According to another aspect of the invention, there is provided an electronic device, comprising a display, a keyboard, and a controller operationally connected to the keyboard and the display, wherein the controller is configured to display on the display a document comprising several elements capable of obtaining focus. The controller is further configured to define a pre-determined number of focus nodes on the display, associate each focus node with a press of a predetermined key of the keyboard, detect a press of a key of the keyboard, select a focus node on the basis of the detected key press, determine the element capable of obtaining focus, which is closest to the selected focus node, and set focus to the determined element.

According to another aspect of the invention, there is provided a computer program product encoding a computer program of instructions for executing a computer process for enhancing document viewing in an electronic device, wherein a document comprising several elements capable of obtaining focus is displayed on a display of the device, the process comprising: defining a predetermined number of focus nodes on the display, associating each focus node with a predetermined key press, detecting a key press, selecting a focus node on the basis of the key press, determining the element capable of obtaining focus, which is closest to the selected focus node, and setting focus to the determined element.

According to yet another aspect of the invention, there is provided a computer program distribution medium readable by a computer and encoding a computer program of instructions for executing a computer process for enhancing document viewing in an electronic device, wherein a document comprising several elements capable of obtaining focus is displayed on a display of the device, the process comprising: defining a predetermined number of focus nodes on the display, associating each focus node with a predetermined key press, detecting a key press, selecting a focus node on the basis of the key press, determining the element capable of obtaining focus, which is closest to the selected focus node, and setting focus to the determined element.

The invention provides several advantages. The invention enhances document viewing especially in devices in which a keyboard is the main input device and where a mouse is not necessarily utilised.

For example, when browsing a web page, scrolling a page is the most common user action, since typically a part or most of the web page is outside the visible web page window. Prior-art solutions require that a user move focus over the whole visible web page area in order to scroll with a single hard key, or press a rather strange combination of direction keys to achieve this kind of scrolling. This usually requires several key presses.

The presented solution allows a user quickly to set focus to a certain web page window area and to scroll the web page with a minimum number (usually two) of key presses and with a single hardware key. Furthermore, in the presented solution, the position where focus will be on the screen is more consistent with user expectations than with the prior-art solutions. Also, the average distance to reach any link element on the screen after focus setting is shorter than with the prior-art solutions, i.e. fewer key presses are required to reach an element.

### LIST OF DRAWINGS

In the following, the invention will be described in greater detail with reference to the embodiments and the accompanying drawings, in which

FIGS. 1A and 1B illustrate examples of an electronic device;

FIG. 2 is a flowchart illustrating an embodiment of the invention,

FIGS. 3A to 3C illustrate a display of the electronic device, and

FIGS. 4A and 4B illustrate embodiments where frames are utilised.

### DESCRIPTION OF EMBODIMENTS

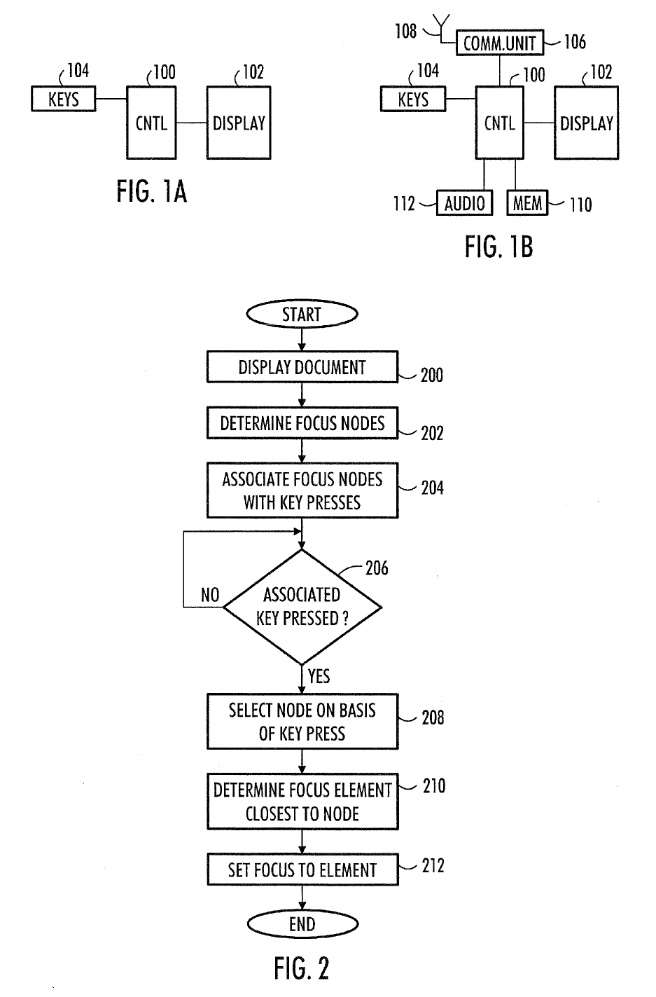

With reference to FIG. 1A, examine an example of an electronic device to which embodiments of the invention can be applied. The electronic device comprises a controller 100, typically implemented with a microprocessor, a signal processor or separate components and associated software. The device further comprises a display 102. The display is typically configured to display graphics and text. The device also comprises a keyboard 104. Depending on the type of the device, there may be various user interface parts and their numbers may vary.

In an embodiment of FIG. 1B, the device may also comprise communication means 106 enabling the device to set up wireless or wireline connections. The communication means may implement the functions of terminal equipment including speech and channel coders, modulators, and RF parts. The device may also comprise an antenna 108. The communication means may also be a Bluetooth® transceiver or a WLAN (Wireless Local Area Network) transceiver. In an embodiment, the communication means provide the device with a wireline connection to a communication network, such as the Internet. In such a case, the communication means may be a network adapter known to persons skilled in the art. The device also typically comprises a memory 110 for storing for instance telephone numbers, calendar data, and other user-specific data, and an audio interface 112, which typically comprises a microphone and a loudspeaker.

The electronic device is not restricted to the above example. The electronic device may be a personal computer, a personal digital assistant, terminal equipment or any other device comprising a display, keyboard and means to display documents on the display.

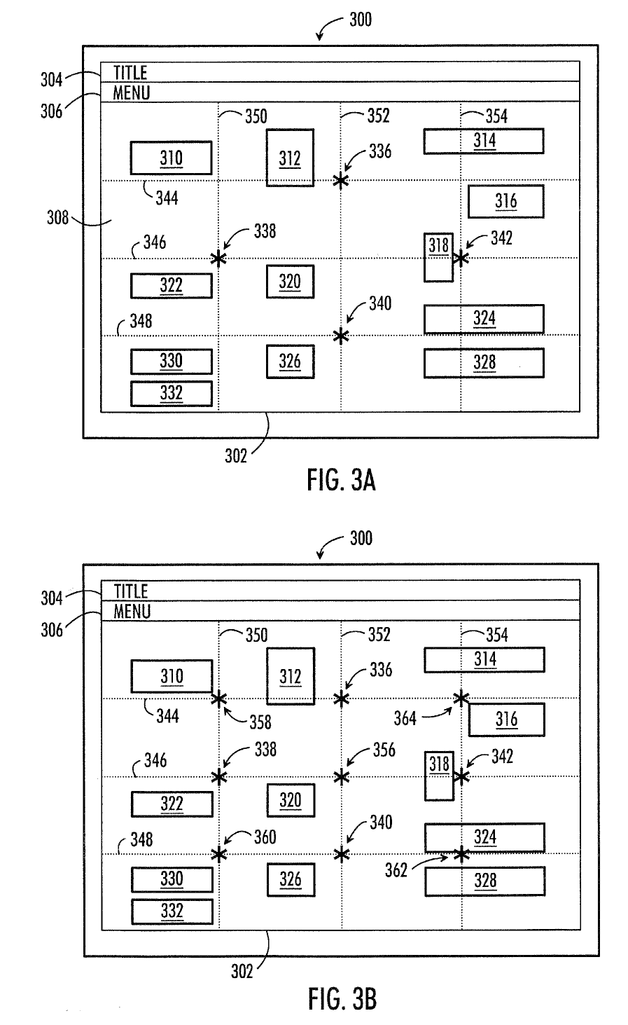

With reference to the flowchart of FIG. 2, examine an example of an embodiment of the invention. In step 200, a document is displayed on a display of an electronic device. The document comprises several elements capable of obtaining focus. The document may be displayed by a suitable application. An example of such an application is a web browser displaying a web page comprising links to other pages or other sections of the page.

In step 202, a predetermined number of focus nodes are defined on the display. In an embodiment, the focus nodes are defined in the area of the display where the document is shown. The area may be the area of the display used by the application. In an embodiment, the area is the client area of the application displaying the document on the display. The client area is the application content area within the application window. The application window is the area used by the application on the display, and the client area is the area within the application window reserved for displaying the document.

In step 204, the focus nodes are associated with a predetermined key press. Assume that four nodes are defined in step 202, the nodes being in the top, left, bottom and right section of the display. In step 204, the four nodes are associated with the up, left, down and right arrow keys, for example. Arrow or direction keys are typically suitable for associations, but it is naturally possible to associate any key of the keyboard with any node.

It should be noted that the above steps may also be performed in a different order. The steps 202 and 204 may be performed prior to the step 200 of displaying any document on the display.

In step 206, it is checked whether a key with an association has been pressed. If this is the case, a focus node is selected on the basis of the detected key press in step 208.

In step 210, the element capable of obtaining focus that is closest to the selected focus node is determined. The search for the closest element may be done for instance by calculating the distance from the nearest edge and centre points of elements to the selected node and selecting the element with the shortest distance. There are also other ways of implementing the search, as person skilled in the art is aware.

In step 212, the focus is set to the determined element.

Navigating a document such as a web page, with the keys of a keyboard is usually done with the four arrow or direction keys. In an embodiment of the invention, these arrow keys are used to insert focus to a certain area of the document window. When entering a document, focus is by default not in any particular focus element in the document. The user sets one focus element to be active by pressing a key. According to what key the user has pressed, the starting point of focus is up, down, left, or right on the view.

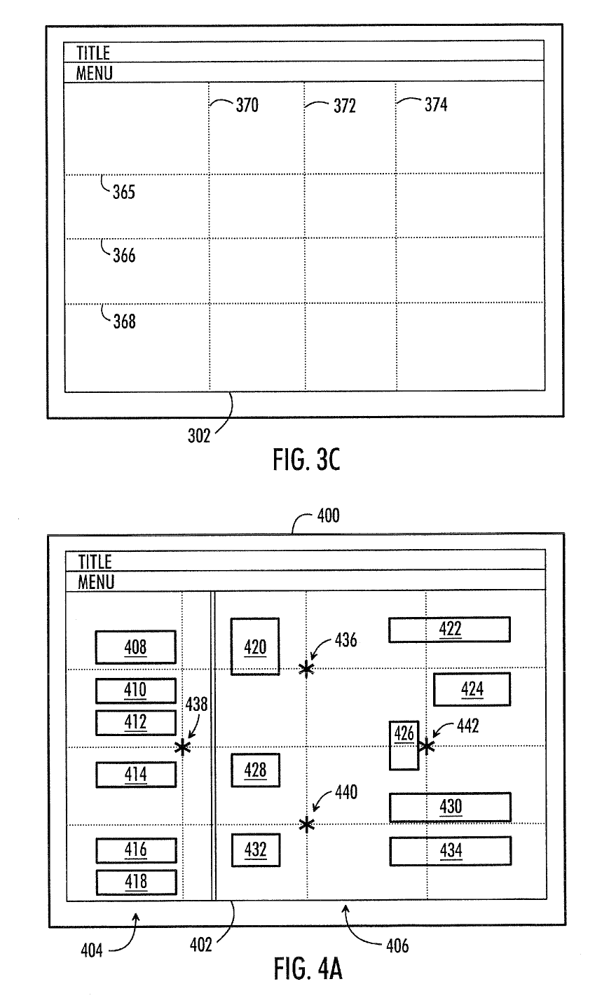

FIG. 3A illustrates an embodiment where four focus nodes are defined on the display. FIG. 3A shows the display 300 of an electronic device. On the display, an application window 302 is displayed. The application may be a web browser, or a word processing application, or any other application configured to display documents comprising elements capable of obtaining focus. In the example of FIG. 3, the application window comprises a title bar 304, which displays the application title, a menu bar 306, which displays the available menu commands, and a client area 308, which displays the currently viewed document. The currently viewed document includes several elements 310 to 332 capable of obtaining focus.

In the example of FIG. 3A, four focus nodes 336 to 342 are defined. Each focus node is associated with a predetermined key press. Node 336 is associated with the ‘up’ arrow key, node 338 is associated with the ‘left’ arrow key, node 340 is associated with the ‘down’ arrow key and node 342 is associated with the ‘right’ arrow key. Thus, if user presses the ‘up’ arrow key after the document has been displayed on the screen, focus is moved to the focus element nearest to the focus node 336. In this case the element is 312. If the user presses the ‘left’ arrow key, focus is moved to the focus element 322, which is nearest to the focus node 338.

FIG. 3A also illustrates an embodiment for defining the location of focus nodes. In this example, the predetermined number of focus nodes are defined in the client area 302 of the application displaying the document on the display. It is also possible to define the focus nodes in the area reserved for the application showing the document, i.e. the application window 302. In another embodiment, the area is the whole area of the display.

In the case of FIG. 3A, the client area 302 of the application is divided into 16 segments with three horizontal 344 to 348 and three vertical 350 to 354 equally spaced lines. The lines are not visible to the user. At least some of the focus nodes may be defined at the intersections of the lines.

Node 336 is defined at the intersection above the centre of the display, node 338 is defined at the intersection left to the centre of the display, node 340 is defined at the intersection below the centre of the display, and node 342 is defined at the intersection right to the centre of the display.

Referring to FIG. 3B, in an embodiment, node 356 is defined in the intersection in the centre of the display. The node may be associated with an ‘Ok’ key of the keyboard, for example. In an embodiment, a node is defined in every intersection, as FIG. 3B illustrates. Nodes 358 to 364 may be associated with the keys 7, 9, 1, and 3 of the numeric keypad of the keyboard, for example. In addition, there are devices equipped with a multidirectional rocker key, which may be a 4-way rocker or an 8-way rocker. In the latter case, all the nodes 336 to 342 and 358 to 364 of FIG. 3B may be associated with the rocker key.

Referring to the example of FIG. 3C, the client area 302 of the application may be divided into 16 segments with three horizontal 365 to 368 and three vertical 370 to 374 lines which are not equally spaced. In an embodiment, the lines in the centre of the display are closer to each other than the lines nearer the borders of the display. Thus, the node points defined in the intersections of the lines are closer to each other in the centre of the display.

It should be noted that the focus nodes may also be defined without the help of lines 344 to 348 and 350 to 354 and their intersections. If segments are utilised, their number may naturally be other than 16.

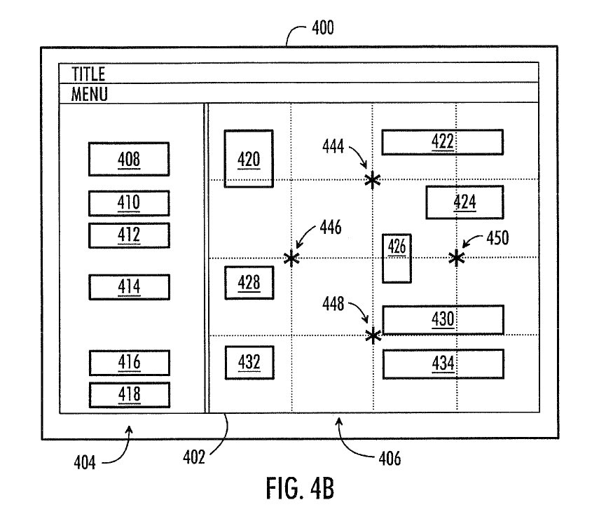

In some embodiments, an application may utilise frames when displaying documents. When frames are utilised, the client area of an application window is divided into two or more individually scrollable regions. FIG. 4A illustrates a display 400 where an application window 402 comprises two frames 404 and 406. The frame 404 on the left side comprises elements 408 to 418 and the frame 406 on the right comprises elements 420 to 434. Both frames may display different sections of the same document. In an embodiment, the frames are ignored when focus nodes are defined. Thus, in the case of four focus nodes, the whole client area of the application window 402 is taken into account when dividing the area into 16 segments. The four focus nodes are at intersections 436 to 442. Thus, it is possible for the user to move the focus to any element quickly, regardless of the frame where the element is.

FIG. 4B illustrates a display 400 where an application window 402 comprises two frames 404 and 406. The frame 404 on the left side comprises elements 408 to 418 and the frame 406 on the right comprises elements 420 to 434. Both frames may display different sections of the same document or different documents may be displayed in different frames. In an embodiment, the frames are not ignored when focus nodes are defined. For example, if the user selects the frame 406 on the right, only the client area of the application window 402 belonging to the frame 406 is taken into account when dividing the area into 16 segments. In this case, the four focus nodes are at intersections 444 to 450. If the user selects the frame 404 on the left, new focus nodes may be defined.

The embodiments of the invention may be realized in an electronic device, comprising a display, a keyboard, and a controller operationally connected to the keyboard and the display, for example. The controller may be configured to perform the steps described in connection with the flowchart of FIG. 2 and in connection with FIGS. 3A, 3B, 3C, 4A, and 4B. The embodiments may be implemented as a computer program comprising instructions for executing a computer process for enhancing document viewing in an electronic device, wherein a document comprising several elements capable of obtaining focus is displayed on a display of the device.

The computer program may be stored on a computer program distribution medium readable by a computer or a processor. The computer program medium may be, for example, but not limited to, an electric, magnetic, optical, infrared, or semiconductor system, device, or transmission medium. The medium may be a computer-readable medium, a program storage medium, a record medium, a computer-readable memory, a random access memory, an erasable programmable read-only memory, a computer-readable software distribution package, a computer-readable signal, a computer-readable telecommunications signal, and a computer-readable compressed software package.

Even though the invention is described above with reference to an example according to the accompanying drawings, it is clear that the invention is not restricted thereto but can be modified in several ways within the scope of the appended claims.

1. A method of enhancing document viewing in an electronic device, wherein a document comprising several elements capable of obtaining focus is displayed on a display of the device, the method comprising
defining a predetermined number of focus nodes on the display,
associating each focus node with a predetermined key press,
detecting a key press,
selecting a focus node on the basis of the key press,
determining the element capable of obtaining focus, which is closest to the selected focus node, and
setting focus to the determined element.

2. The method of claim 1, the method further comprising defining the predetermined number of focus nodes in the area of the display where the document is shown.

3. The method of claim 1, the method further comprising defining the predetermined number of focus nodes on the client area of the application displaying the document on the display.

4. The method of claim 1, the method further comprising associating the focus nodes with the arrow keys of the keyboard of the electronic device.

5. The method of claim 1, the method further comprising associating the focus nodes with the direction keys of the keyboard of the electronic device, the direction keys being configured to move a cursor on the display of the device.

6. The method of claim 1, the method further comprising dividing the area of the display, where the document is shown, or the client area of the application into 16 segments with three horizontal and three vertical lines,
defining at least some of the focus nodes at the intersections of the lines.

7. The method of claim 6, the method further comprising defining four nodes,
the first at the intersection above the centre of the display,
the second at the intersection below the centre of the display,
the third at the intersection left to the centre of the display and
the fourth at the intersection right to the centre of the display.

8. The method of claim 1, the method further comprising defining a node at every intersection.

9. The method of claim 7, the method further comprising associating
the first node with the ‘up’ direction key of the keyboard of the device,
the second node with the ‘down’ direction key of the keyboard of the device,
the third node with the ‘left’ direction key of the keyboard of the device, and
the fourth node with the ‘right’ direction key of the keyboard of the device.

10. The method of claim 6, the method further comprising defining a node at the intersection in the centre of the display, and associating the node with the ‘Ok’ key of the keyboard of the device.

11. An electronic device, comprising
a display, a keyboard, and a controller operationally connected to the keyboard and the display, wherein the controller is configured to display on the display a document comprising several elements capable of obtaining focus, and the controller being further configured to
define a predetermined number of focus nodes on the display,
associate each focus node with a press of a predetermined key of the keyboard,
detect a press of a key of the keyboard,
select a focus node on the basis of the detected key press,
determine the element capable of obtaining focus, which is closest to the selected focus node, and
set focus to the determined element.

12. The electronic device of claim 11, wherein the controller is configured to define the predetermined number of focus nodes on the area of the display where the document is shown.

13. The electronic device of claim 11, wherein the controller is configured to associate the focus nodes with the arrow keys of the keyboard.

14. The electronic device of claim 11, wherein the controller is configured to associate the focus nodes with the direction keys of the keyboard, the direction keys being configured to move a cursor on the display.

15. The electronic device of claim 11, wherein the controller is configured to divide the area of the display, where the document is shown, or the client area of the application into 16 segments with three horizontal and three vertical lines, and to define at least some of the focus nodes at the intersections of the lines.

16. The electronic device of claim 14, wherein the direction keys are realized with a multidirectional rocker key.

17. The electronic device of claim 15, wherein
the controller is configured to
define a first node at the intersection above the centre of the display and associate the node with the ‘up’ direction key of the keyboard,
define a second node defined at the intersection below the centre of the display, and associate the node with the ‘down’ direction key of the keyboard,
define a third node at the intersection left to the centre of the display and associate the node with the ‘left’ direction key of the keyboard, and to
define a fourth node at the intersection right to the centre of the display and associate the node with the ‘right’ direction key of the keyboard.

18. A computer program product encoding a computer program of instructions for executing a computer process for enhancing document viewing in an electronic device, wherein a document comprising several elements capable of obtaining focus is displayed on a display of the device, the process comprising:
defining a predetermined number of focus nodes on the display,
associating each focus node with a predetermined key press,
detecting a key press,
selecting a focus node on the basis of the key press,
determining the element capable of obtaining focus, which is closest to the selected focus node, and
setting focus to the determined element.

19. A computer program distribution medium readable by a computer and encoding a computer program of instructions for executing a computer process for enhancing document viewing in an electronic device, wherein a document comprising several elements capable of obtaining focus is displayed on a display of the device, the process comprising:
defining a predetermined number of focus nodes on the display,
associating each focus node with a predetermined key press,
detecting a key press,
selecting a focus node on the basis of the key press,
determining the element capable of obtaining focus, which is closest to the selected focus node, and
setting focus to the determined element.

20. The computer program distribution medium of claim 19, the distribution medium including at least one of the following mediums: a computer-readable medium, a program storage medium, a record medium, a computer-readable memory, a computer-readable software distribution package, a computer-readable signal, a computer-readable telecommunications signal, and a computer-readable compressed software package.
